(19) United States
(12) Patent Application Publication
(10) Pub. No.: US 2004/0083398 A1
(43) Pub. Date: Apr. 29, 2004

(54) Methods and apparatus for setting a bus-to-core ratio of a multi-processor platform

(75) Inventors: Frank L. Wildgrube, Hillsboro, OR (US); Clint J. Hutzenbiler, Portland, OR (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 10/282,895

(22) Filed: Oct. 29, 2002

(51) Int. Cl. G06F 1/12

(52) U.S. Cl. 713/400

(57) ABSTRACT

In a multiple-processor platform, various methods are executed for evaluating and harmonizing bus-to-core ratios among the multiple processors. The methods can execute before random-access memory is activated. In one embodiment, the method includes aliasing an advanced programmable interrupt controller base memory specific register to a different address within the system basic input/output system. The methods allow for the addition and/or replacement of processors on the multiple-processor platform. A multiple-processor platform system and a computer-readable medium are also described.

### TECHNICAL FIELD

Embodiments of the present invention relate to methods and apparatus for setting bus-to-core ratios in a multi-processor platform system. More particularly, in at least one embodiment a software method sets bus-to-core ratios before random-access memory in the system is detected.

### BACKGROUND INFORMATION

### DESCRIPTION OF RELATED ART

An integrated circuit (IC) die is often fabricated into a processor for various tasks. Similarly, various ICs are mounted onto a single platform for parallel operation. For example, a parallel-processing platform can have at least two identical processors that carry out shared processing burdens. In another example, a parallel-processing platform can have at least two dissimilar processors that carry out similar or complementary processing burdens. A single platform can be a system that is the focus point for a plurality of processors that have different capabilities. Consequently, initializing the system requires an evaluation and harmonization of the various processors' capabilities.

Typically, a processor is attached to a bus that in turn is attached to a bridge. The bridge, bus, and processors are mounted on a platform with other devices. The bus is commonly the attachment location for the other devices. The processor often operates at a clock speed or frequency that is several orders of magnitude higher than the capability of the bus. Consequently, a bus frequency-to-processor frequency (“bus-to-core”) ratio must be established for which the operational processor speed is a multiple of the operational bus frequency.

When a multiple-processor platform is implemented, an establishment, of the bus-to-core ratio (“BCR”) must be evaluated and harmonized for a synchronous system. This evaluation and harmonization must be carried out each time the platform is turned on or is reset.

FIG. 1 is a schematic of a portion of an existing multi-processor platform system 100. The system 100 includes a bridge 110 and a plurality of processors. The plurality of processors includes central processing unit 0 (“CPU0”) 112, CPU1 114, and up to CPUn 116. The plurality of processors CPU0 112, CPU1 114, to CPUn 116 are coupled to the bridge 110 by a bus 118.

A switching device 120 is also provided. The switching device 120 has three configurations. When no connection is made between pins 122, 124, and 126, the signal is pulled to Vcc through the pin 124. When a connection is made between pins 122 and 124, the chipset of the platform system 100 drives the signal when coming out of reset. When a connection is made between pins 124 and 126, the signal is pulled to ground. In prior multi-processor platforms such as the one depicted in FIG. 1, four pins were used for establishing common BCRs where the BCRs were one of 16; the ratios range from 8:1 up to 24:1. In each processor 112, 114, and 116, these pins were connected to a phase-locked loop (“PLL”) that locked selected BCRs that were common across all the processors 112, 114, and 116 of the multiple-processor platform system 100.

Evaluation and harmonization of a plurality of processors is a time-consuming process that requires the activation of random-access memory (“RAM”). For example, the system basic input/output system (“system BIOS”) must write the BCR to a model-specific register (“MSR”) in each processor on the platform. For a partially populated multiple-processor platform, the addition and/or exchange of processors may happen in the field according to the user's applications. The evaluation and harmonization must therefore be performed each time the platform system is switched on or is reset.

After a “power on” or “reset” has been executed for a multiple-processor platform system, only one of the processors begins to execute the system BIOS. That processor is called the Boot-Strap Processor (“BSP”). The BSP then begins activating the other processor(s) on the platform. The other processors are called the Application Processors (“APs”). The BSP directs each AP to set its minimum and maximum BCRs with ratios that have been evaluated and harmonized for the entire multiple-processor platform system 100. After the system BIOS has written BCRs, the system BIOS is obliged to generate a hard reset for all of the processors to begin operating with the newly evaluated and harmonized BCRs.

For the BSP to direct each AP to reset its BCRs, the BSP must send a Startup InterProcessor Interrupt (“SIPI”) to each AP. This is done by placing the system BIOS into a different mode. A “flat model” mode is real mode, but it has set the global-descriptor table (“GDT”) to a limit of 4 gigabytes (“GB”). However, to set up flat model mode, each processor must transition into “protected” mode, as is known in the art, and then switch back to real mode. In protected mode, the BSP is able to send the SIPIs to the various APs. Unfortunately, for time and various other reasons, the system BIOS does not activate the other processors until random-access memory (“RAM”) is available. Such a method is time-consuming and adds to the “dead time” for a user while the multiple-processor platform system is coming on line.

### BRIEF DESCRIPTION OF THE DRAWINGS

In order to understand the manner in which embodiments of the present invention are obtained, a more particular description of various embodiments of the invention briefly described above will be rendered by reference to the appended drawings. Understanding that these drawings depict only typical embodiments of the invention that are not necessarily drawn to scale and are not therefore to be considered to be limiting of its scope, the embodiments of the invention will be described and explained with additional specificity and detail through the use of the accompanying drawings in which:

FIG. 1 is a schematic of a portion of an existing multiple-processor platform system;

FIG. 2 is a schematic of a portion of a multiple-processor platform system according to an embodiment of the present invention; and FIG. 3 is an algorithm diagram that depicts bus-to-core ratio setting methods according to embodiments of the present invention.

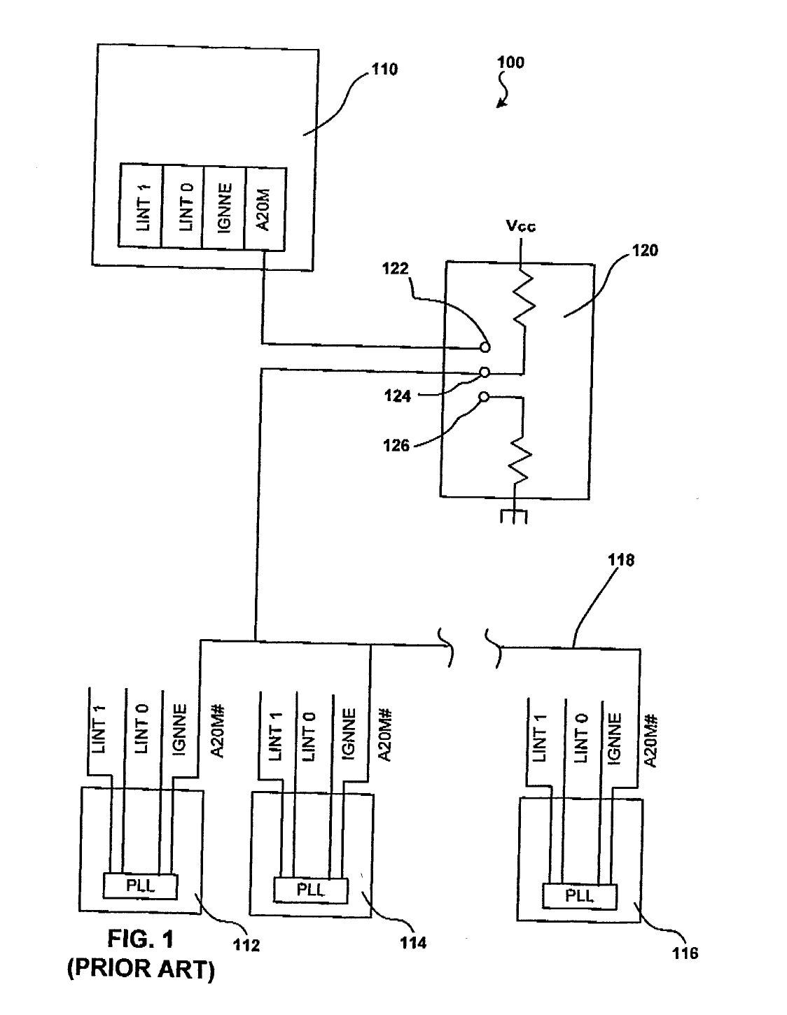

### DETAILED DESCRIPTION

The following description includes terms, such as first, second, etc., that are used for descriptive purposes only and are not to be construed as limiting. In the following detailed description, reference is made to the accompanying drawings, which form a part hereof. These drawings show, by way of illustration, specific embodiments in which the invention may be practiced. In the drawings, like numerals describe substantially similar components throughout the several views. These embodiments are described in sufficient detail to enable those skilled in the art to practice such embodiments of the invention. Other embodiments may be used, and structural, logical, and electrical changes may be made without departing from the scope of the inventive concepts.

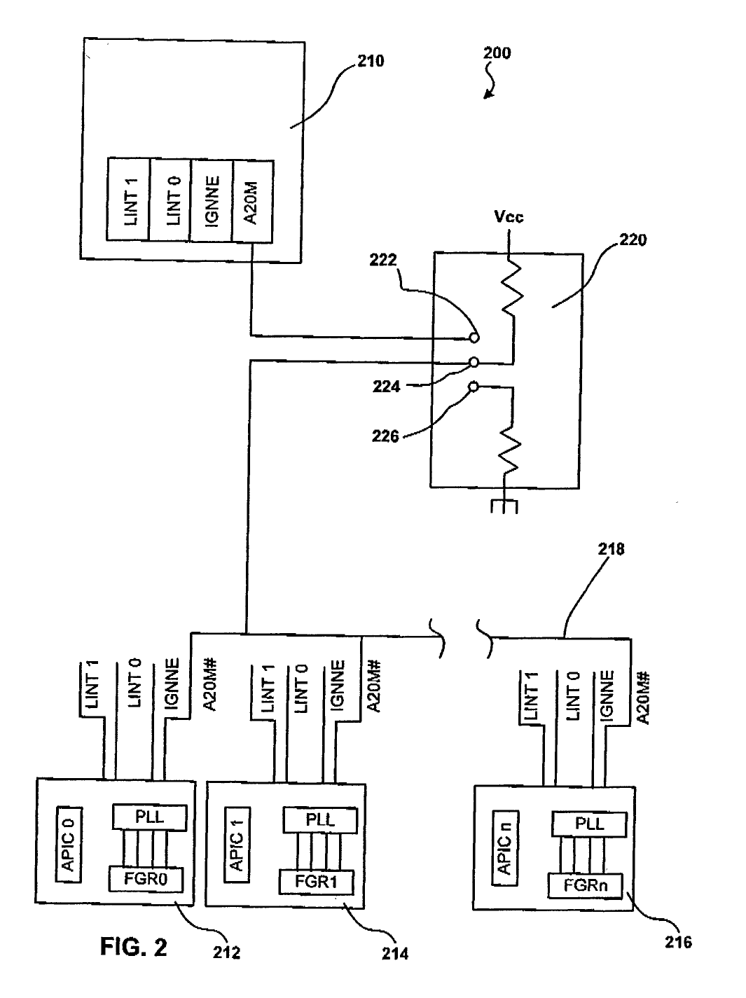

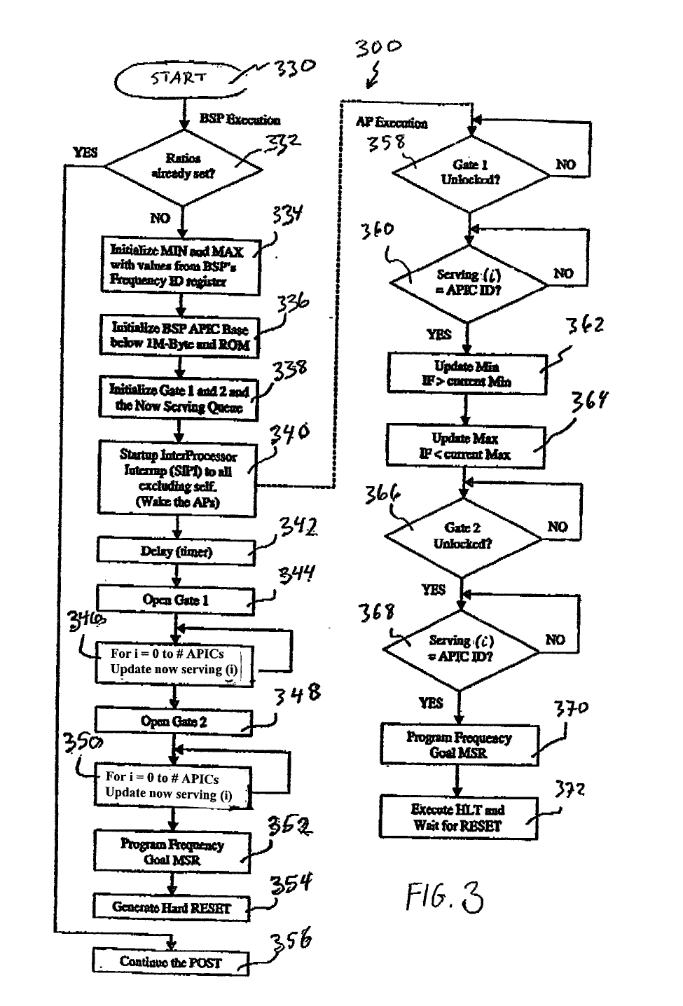

FIG. 2 is a schematic of a portion of a multi-processor platform system 200 according to an embodiment. The multi-processor platform system 200 includes a bridge 210 and a plurality of processors. In one embodiment, the bridge 210 is a “south bridge” according to known platform systems; however, it will be understood by those of ordinary skill in the art that other architecture, including bridges, could be substituted. The plurality of processors includes CPU0 212, CPU1 214, up to an n^{th} CPU that is referred to as CPUn 216. The plurality of processors CPU0 212, CPU1 214, to CPUn 216 are coupled to the bridge 210 by a bus 218.

A switching device 220 is also provided. The switching device has three configurations. When no connection is made between pins 222, 224, and 226, the signal is pulled to Vcc through the pin 224. When a connection is made between pins 222 and 224, the chipset of the multi-processor platform system 200 drives the signal to reset. When a connection is made between pins 224 and 226, the signal is pulled to ground. (In prior multi-processor platforms, where four pins were used for establishing common bus-to-core ratios, the connection to a PLL in each processor was internal between an MSR that is the frequency goal register (“FGR”).) However, in the embodiment illustrated in FIG. 2, up to 256 bus-to-core ratios (“BCRs”) or more are enabled by a software solution, and the PLLs are not directly coupled to the four pins.

In FIG. 2, a PLL in each processor CPU1 214 to CPUn 216 is coupled to a respective frequency goal register (“FGR”), such as FGR0, FGR1, and FGRn. The FGRs are model-specific registers (MSRs).

In FIG. 2, an advanced programmable interrupt controller (“APIC”) is provided in each processor CPU1 214 to CPUn 216, in the form of APIC0, APIC1, through APICn, respectively. Each APIC has an APIC identification number. A method of setting common BCRs includes a boot-strap processor (“BSP”) and at least one application processor (“AP”). The BSP is designated or elected by the hardware setup by the manufacturer, although other methods of electing the BSP can be done. In the exemplary embodiment of FIG. 2, the BSP is CPU0 212, and a plurality of APs include CPU1 214 to CPUn 216.

Upon a hard boot, or a hard reset, the hardware elects CPU0 212 to be the BSP. The BSP CPU0 212 closes two software gates that are used to set BCRs for the multi-processor platform system 200. The BSP initiates a “now serving” queue that processes the APs CPU1 214 to CPUn 216 in an order based upon their respective APIC identification numbers.

The system basic input/output system (“BIOS”) relocates the APIC Register Block base address (“APIC Base”) of the BSP CPU0 212 to a memory address that is below one megabyte. By relocating the APIC base of the BSP CPU0 212 to below one megabyte, the system BIOS can write directly to the APIC registers of the other APs CPU1 214 to CPUn 216 without activating random-access memory (“RAM”). By relocating the APIC base of the BSP CPU0 212 to below one megabyte, the space that was previously required to transition into flat model or protected mode, and back to real mode, is not required. Consequently, significant time is saved by the relocation of the APIC base of the BSP CPU0 212 to below one megabyte. Additionally, a 16-bit offset scheme can be used in which the lower 16 bits of a register are used in real mode. Consequently, the upper 16 bits are available for variable storage. It will be understood by those of ordinary skill in the art that the altered memory location is a function of the particular system architecture and is not necessarily limited to the examples discussed herein.

Next, the BSP CPU0 212 initializes a minimum BCR and a maximum BCR (“MIN/MAX BCRs”) by using its own MIN/MAX BCRs as the default. After having initialized the MIN/MAX BCRs for the system, the BSP CPU0 212 sends a Startup InterProcessor Interrupt (“SIPI”) to the APs CPU1 214 to CPUn 216. After the APs CPU1 214 to CPUn 216 receive the SIPI, they race to the first software gate. At the first software gate, the BSP CPU0 212 has written an APIC identification number to an I/O port chipset scratch register, or to a complimentary metal oxide semiconductor (“CMOS”) location that the APs CPU1 214 to CPUn 216 are polling. The BSP CPU0 212 has a “now serving” queue that opens the APs CPU1 214 through CPUn 216 to evaluating and harmonizing their own MIN/MAX BCRs with the system 200.

When an i^{th} AP (in this example, the first AP CPU1 214) sees its APIC identification number in the “now serving” queue, it enters a first critical software region through the first software gate, and it updates the MIN/MAX BCRs that were previously the system default of the BSP CPU0 212. For example, the i^{th} AP evaluates its own MIN BCR, compares it with the current system MIN BCR (that of the BSP CPU0 212 in this example), and harmonizes it by selecting the largest MIN BCR between the system MIN BCR and its own MIN BCR. The MIN BCR overwrites the previous MIN BCR of the BSP CPU0 212 if it is larger than the MIN BCR of the system.

Next, the i^{th} AP evaluates its own MAX BCR, compares it with the current system MAX BCR (that of the BSP CPU0 212 in this example), and harmonizes it by selecting the smallest MAX BCR between the system MAX BCR and its own MAX BCR. The MAX BCR overwrites the previous MAX BCR of the BSP CPU0 212 if it is smaller than the MAX BCR of the system. The i^{th} AP then waits at a second software gate.

Next in this example, the BSP CPU0 212 increments the APIC identification number and checks to determine if all APs, CPU1 214 to CPUn 216, have been incremented.

Next, when the i+1^{st} AP sees its APIC identification number in the “now serving” queue, it enters the first critical software region and updates the MIN/MAX BCRs in a manner similar to that of the i^{th} AP. This is accomplished by evaluating and harmonizing its own MIN/MAX BCRs with the latest system MIN/MAX BCRs that were established when the i^{th} AP was used in evaluation and harmonization. Accordingly, the i+1^{st} AP evaluates its MIN BCR by comparing its own MIN BCR with the current MIN BCR of the system, and harmonizes them by selecting the larger MIN BCR of the two. And finally, the i+1^{t} AP evaluates its MAX BCR by comparing its own MAX BCR with the current MAX BCR of the system, and harmonizes them by selecting the smaller MAX BCR of the two. Next, the i+1^{st} AP waits at a second software gate.

Ultimately, when the n^{th} AP (in this example AP CPUn 216) sees its APIC identification number in the “now serving” queue, it enters the first critical software region and updates the system MIN/MAX BCRs as set forth herein. Next, the n^{th} AP waits at a second software gate until the BSP CPU0 212 observes that all of CPU1 214 to CPUn 216 have been evaluated.

When the BSP CPU0 212 has determined that all of CPU1 214 to CPUn 216 have been evaluated, the BSP CPU0 212 generates a reset command. All of the processors latch the latest system MIN/MAX BCRs by passing the second software gate, and by receiving an overwrite from the updated system MIN/MAX BCRs such that they are harmonized for the entire multiple-processor platform system 200.

Where a mobile multiple-processor platform system is being used, it defaults to the MIN BCR for energy conservation purposes. Where a “desktop” or “workstation” multiple-processor platform system is connected to an alternating current (“AC”) source, it defaults to the MAX BCR for the speed advantage. For a mobile multiple-processor platform system, a periodic inquiry is made to determine if it is drawing from battery or AC, and if it is drawing from AC, a switch is made to the MAX BCR. Similarly, the same periodic inquiry can be made to determine if the mobile multiple-processor platform system (that was previously operating off an AC source) is operating on battery power, and if it is operating on battery power, a switch is made to the MIN BCR.

FIG. 3 is an algorithm diagram that depicts bus-to-core ratio setting methods 300. At 330, the algorithm starts with either a hard boot or a hard reset. The hard boot or hard reset can follow a reconfiguration of a multiple-processor platform system such as the multiple-processor platform system 200 depicted in FIG. 2. The reconfiguration can include the addition of another processor, the swapping of one processor for another one, or both.

At 332, the algorithm queries whether the MIN/MAX BCRs have already been set. This query can occur for example, when a multiple-processor platform system has gone into a low-power consumption mode such as an extended time of no activity. This is often called “sleep” mode and applies to the entire multiple-processor platform system. If the MIN/MAX BCRs have already been set, the algorithm goes to 356. At 356, the multiple-processor platform system continues to a power-on self-test (“POST”) as is known in the art.

At 332, if the MIN/MAX BCRs have not already been set, the algorithm proceeds to 334.

At 334, initial MIN/MAX BCRs are established by using the MIN/MAX BCRs from the BSP. In relation to the multiple-processor platform system 200 depicted in FIG. 2, this is the BSP CPU0 212. In one embodiment, the MIN/MAX BCRs are obtained from a Frequency ID register of the BSP CPU0 212.

At 336, the APIC base of the BSP is initialized below one megabyte in the system address space. The APIC base of the BSP is relocated by the system BIOS to a memory address below 1 MB to 64 KB. This aliasing allows the system BIOS to write directly to the APIC registers of the BSP without the use of RAM. By relocating the APIC base of the BSP CPU0 212 to below one megabyte, the space that was previously required to transition into flat model or protected mode, and back to real mode, is not required. Consequently, significant time is saved by the relocation of the APIC base of the BSP CPU0 212 to below one megabyte.

At 338, the two software gates (Gate 1 and Gate 2) are initialized in preparation to allow the APs to indicate their readiness to pass through. Additionally, the “now serving” queue is initialized. For the multiple-processor platform system 200 depicted in FIG. 2, the APs include CPU1 214 to CPUn 216. The “pass through” for the APs relates to their being polled by the respective Gates 1 and 2 to see if their individual APIC identification numbers are next in the “now serving” queue.

At 340, the APs are awakened by the SIPI in the BSP. The APs are awakende at an address below 1MB such as 1 MB-64 KB, such that they wake up to a memory address that will be decoded by ROM.

For the multiple-processor platform system 200 depicted in FIG. 2, the BSP CPU0 212 executes an SIPI to the APs CPU1 214 to CPUn 216. The APs then race to the first software gate (Gate 1). The BSP meanwhile has written an APIC identification number to an input/output (“I/O”) port chipset scratch register, or to a CMOS location. The APs continually poll the I/O port or the CMOS location to determine if their individual APIC identification number is in the “now serving” queue. For the multiple-processor platform system 200 depicted in FIG. 2, the BSP CPU0 212 has written an i^{th} APIC identification number to the I/O port or to the CMOS location, and when the i^{th} AP polls the location and confirms that its APIC identification number is in the “now serving” queue, it moves into the first critical software region.

At 342, a delay timer is used to allow all the APs to have reached the first software gate.

At 344, (assuming that all the APs have reached Gate 1), Gate 1 is opened, and the APs enter the first critical software region. For each AP, individual evaluation and harmonization of its MIN/MAX BCRs with the system MIN/MAX BCRs continues at 358. The individual evaluation and harmonization of its MIN/MAX BCRs is discussed below.

At 346, the “now serving” queue increments from the 1ₛₜ AP, up to the n^{th} AP. For the multiple-processor platform system 200 depicted in FIG. 2, the APs CPU1 214 to CPUn 216 are serially evaluated, and the platform system is harmonized. In one embodiment, the APs are configured in a series physically across a multiple-processor platform system, and the APs are serially evaluated and their BCRs harmonized according to their serial location proximate a given region such as their location along a bus, their respective distances from the BSP, or their respective distances from the bridge, or other schemes. hi another embodiment, the APs are serially evaluated and their BCRs harmonized according to their source of manufacture, as APs that come from the same source can have similar identification codes. In another embodiment, the APs are serially evaluated and their BCRs harmonized according to their order of placement upon the multiple-processor platform system, such as when a multiple-processor platform system is added to or modified after a previous evaluation and harmonization.

At 348, once all the APs have been evaluated and the multiple-processor platform system has overwritten and/or harmonized its MIN/MAX BCRs for the n^{th} time, the second software gate (Gate 2) is opened and the second software gate polls the APs by their APIC identification numbers by the “now serving” queue.

At 350, the APs are called according to APIC identification numbers by the “now serving” queue. As each AP APIC identification number matches the “now serving” queue, the harmonized MIN/MAX BCRs are written to the individual MSRs of the APs.

In this embodiment, the individual MSR of an AP is referred to as the frequency goal register (“FGR”). Referring back to FIG. 2, each of the APs CPU1 214 to CPUn 216 comprises a respective FGR, such as FGR0 and FGRn. Therefore, at 352, the FGR is written to for the AP in the “now serving” queue, and the MIN/MAX BCRs of the AP are harmonized with the MIN/MAX BCRs of the system. After writing harmonized MIN/MAX BCRs, the BSP increments the APIC identification number to the next AP if there is one, and checks to determine if all APs have been incremented. The BSP is also called in the “now serving” queue and its MIN/MAX BCRs are harmonized with the system MIN/MAX BCRs.

At 354, the multiple-processor platform system generates a hard reset. At this level of the algorithm, all the MIN/MAX BCRs have been evaluated and harmonized, and the multiple-processor platform system continues to power up. Where a mobile multiple-processor platform system is being used, it defaults to the MIN BCR for energy conservation purposes. Where a “desktop” or “workstation” multiple-processor platform system is being used, it defaults to the MAX BCR for the speed advantage. For a mobile multiple-processor platform system, a periodic inquiry is made to determine if the mobile multiple-processor platform system is drawing from battery or from AC, and if it is drawing from AC, a switch is made to the MAX BCR. Similarly, the same periodic inquiry can be made to determine if the mobile multiple-processor platform system (that is incidentally operating off an AC source) is operating on battery power, and if it is operating on battery power, a switch is made to the MIN BCR.

FIG. 3 also illustrates an algorithm for each individual AP as it is evaluated and harmonized. At 358, the i^{th} AP queries if Gate 1 is unlocked. If it is not, it continues to poll Gate 1 until it is unlocked.

At 360 the i^{th} AP queries if the APIC identification number is in the “now serving” queue. If it is not, it continues to poll the “now serving” queue until it is.

At 362 and at 364, if the i^{th} AP has confirmed that the APIC identification number is in the “now serving” queue, it overwrites or harmonizes the system MIN/MAX BCRs if appropriate, as set forth herein.

At 366, the i^{th} AP queries if Gate 2 is unlocked. If it is not, it continues to poll Gate 2 until it is unlocked.

If Gate 2 is unlocked, at 368, the i^{th} AP queries if the APIC identification number is in the “now serving” queue. If it is not, it continues to poll the “now serving” queue until it is.

At 370, the i^{th} AP receives the harmonized system MIN/MAX BCRs and they are written to the FGR of the i^{th} AP.

At 372, the i^{th} AP executes a halt (“HLT”) command and waits for a reset command.

In a first example, a multiple-processor platform system includes processors 0-3. Processor 0 is the BSP that is elected by the hardware, without the use of the system BIOS. Processors 1-3 are three APs. Table 1 illustrates the MIN/MAX BCRs for the various processors at a hard boot or a hard reset.

TABLE 1
Initial MIN/MAX BCRs for a Multiple-Processor Platform System

CPU No.

| | 0 | 1 | 2 | 3 |
|---|---|---|---|---|
| MIN BCR | 16 | 15 | 16 | 20 |
| MAX BCR | 30 | 25 | 25 | 30 |

In this example, the algorithm is followed by calling the individual APs by the APIC identification numbers that correspond to the CPU numbers.

Table 2 illustrates execution of the algorithm upon the system MIN/MAX BCRs for iterations as each AP passes the first software gate. During the “zeroth” iteration, the BSP MIN/MAX BCRs are written to the system MIN/MAX BCR registers.

TABLE 2
System Overwriting During Evaluation of MIN/MAX BCRs

Iteration

| | 0 | 1st | 2nd | 3rd |
|---|---|---|---|---|
| System MIN BCR | 16 | 16 | 16 | 20 |
| System MAX BCR | 30 | 25 | 25 | 25 |

Table 3 illustrates execution of the algorithm upon the individual processors as each passes the second software gate. The BSP MIN/MAX BCRs are overwritten from the system MIN/MAX BCRs as are the MIN/MAX BCRs of the APs.

TABLE 3
Harmonized MIN/MAX BCRs

CPU No.

| | 0 | 1 | 2 | 3 |
|---|---|---|---|---|
| MIN BCR | 20 | 20 | 20 | 20 |
| MAX BCR | 25 | 25 | 25 | 25 |

In one embodiment, the algorithm is lodged in a computer-readable medium. One embodiment of the computer-readable medium is a magneto-optical disk such as a compact disk (“CD”) or a digital video disk (“DVD”). Another embodiment is a magnetic disk such as a removable floppy disk or a hard drive disk. Another embodiment is an original equipment manufacturer (“OEM”) structure that is placed on the platform system such as an electrically erasable programmable read-only memory (“E²PROM”). In another embodiment, the algorithm is lodged in an E²PROM, but a copy of the algorithm is loaded into the system ROM for quicker execution.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description of Embodiments of the Invention, with each claim standing on its own as a separate preferred embodiment.

It will be readily understood to those skilled in the art that various other changes in the details, material, and arrangements of the parts and method stages which have been described and illustrated in order to explain embodiments of this invention may be made without departing from the principles and scope of the invention as expressed in the subjoined claims.

What is claimed is:

1. A method comprising:
electing a bootstrap processor (BSP) after a hard reset or a hard boot for a plurality of processors on a platform system; and
harmonizing common minimum and maximum bus-to-core ratios (MIN/MAX BCRs) for the plurality of processors before making random-access memory available in the system.

2. The method according to claim 1, the method further including:
while in real mode, aliasing an advanced programmable interrupt command (APIC) base memory-specific register to a position below 1 megabyte in the system basic input/output system.

3. The method according to claim 1, the method further including:
while in real mode, aliasing an advanced programmable interrupt command (APIC) base memory-specific register to a position below 1 megabyte in the system basic input/output system; and
harmonizing the MIN/MAX BCRs in a 16-bit offset mode.

4. The method according to claim 1, wherein the plurality of processors includes the BSP and at least one application processor (AP), each having MIN/MAX BCRs collectively referred to as system MIN/MAX BCRs, and wherein harmonizing common MIN/MAX BCRs further includes:
overwriting the system MIN/MAX BCRs with the MIN/MAX BCRs of the BSP;
evaluating the MIN/MAX BCRs for each of the at least one AP with the system MIN/MAX BCRs by:
overwriting the system MIN BCR if the AP MIN BCR is larger than the system BCR; and
overwriting the system MAX BCR if the AP MAX BCR is smaller than the system BCR; and
overwriting the BSP MIN/MAX BCRs and the at least one AP MIN/MAX BCRs with the system MIN/MAX BCRs.

5. The method according to claim 1, after harmonizing common MIN/MAX BCRs for the plurality of processors, the method further including:
detecting a non-battery power source for the system; and
selecting the MAX BCR.

6. The method according to claim 1, after harmonizing common MIN/MAX BCRs for the plurality of processors, the method further including:
detecting an alternating-current power source for the system;
selecting the MAX BCR;
detecting a direct-current power source for the system; and
selecting the MIN BCR.

7. The method according to claim 1, after harmonizing common MIN/MAX BCRs for the plurality of processors, the method further including:
detecting a direct-current power source for the system; and
selecting the MIN BCR.

8. The method according to claim 1, after harmonizing common MIN/MAX BCRs for the plurality of processors, the method further including:
detecting a direct-current power source for the system; and
selecting the MAX BCR;
detecting an alternating-current power source for the system; and
selecting the MIN BCR.

9. The method according to claim 1, after harmonizing common MIN/MAX BCRs for the plurality of processors, for each processor in the system, the method further including:
detecting an alternating-current power source for the system;
selecting the MAX BCR; and
locking the MAX BCR with a phase-locked loop that is internal to the processor.

10. The method according to claim 1, after harmonizing common MIN/MAX BCRs for the plurality of processors, for each processor in the system, the method further including:
detecting a direct-current power source for the system;
selecting the MIN BCR; and
locking the MIN BCR with a phase-locked loop that is internal to the processor.

11. A method comprising:
harmonizing minimum and maximum bus-to-core ratios (MIN/MAX BCRs) for a plurality of processors in a platform system, wherein the MIN BCR is the largest common minimum, wherein the MAX BCR is the smallest common maximum, and wherein harmonizing the MIN/MAX BCRs is executed from read-only memory (ROM).

12. The method according to claim 11 wherein, in harmonizing, the plurality of processors includes a boot-strap processor (BSP) and at least one application processor (AP), each having MIN/MAX BCRs collectively referred to as system MIN/MAX BCRs, and wherein harmonizing further includes:
overwriting the system MIN/MAX BCRs with MIN/MAX BCRs of the BSP;
evaluating the MIN/MAX BCRs of the at least one AP by:
overwriting the system MIN BCR if the AP MIN BCR is larger than the system BCR;
overwriting the system MAX BCR if the AP MAX BCR is smaller than the system BCR; and
overwriting the BSP MIN/MAX BCRs and the at least one AP MIN/MAX BCRs with the system MIN/MAX BCRs.

13. The method according to claim 12, wherein overwriting the BSP MIN/MAX BCRs and the at least one AP MIN/MAX BCRs with the system MIN/MAX BCRs includes locking either a MIN BCR or a MAX BCR for each processor by a phase-locked loop.

14. A method comprising:
altering one of a processor count and a processor configuration of a multiple-processor platform system comprising a plurality of processors;
performing a hard reset or a hard boot of the multiple-processor platform system;
designating a bootstrap processor (BSP) from the plurality of processors; and
harmonizing minimum and maximum bus-to-core ratios for the plurality of processors before making random-access memory available in the system.

15. The method according to claim 14 wherein, in altering, the multiple-processor platform system includes a system basic input/output system (system BIOS), wherein, in designating, the BSP includes an advanced programmable interrupt controller (APIC) having a BSP APIC base in the system BIOS, and following designating a BSP, the method further including:
aliasing the BSP APIC base in the system BIOS to a location below 1 megabyte.

16. The method according to claim 14 wherein, in altering, the multiple-processor platform system includes a system basic input/output system (system BIOS), wherein, in designating, the BSP includes an advanced programmable interrupt controller (APIC) having a BSP APIC base in the system BIOS, wherein, in altering, the plurality of processors includes the BSP and at least one application processor (AP) each having MIN/MAX BCRs collectively referred to as system MIN/MAX BCRs, and following designating a BSP, the method further including:
aliasing the BSP APIC base in the system BIOS to a location below 1 megabyte;
overwriting the system with MIN/MAX BCRs from the BSP; and
harmonizing the BSP MIN/MAX BCRs and the at least one AP MIN/MAX BCRs with the system MIN/MAX BCRs.

17. The method according to claim 16, following harmonizing the BSP MIN/MAX BCRs and the at least one AP MIN/MAX BCRs with the system MIN/MAX BCRs, the method including:
locking either a MIN BCR or a MAX BCR for each of the plurality of processors by a phase-locked loop.

18. A multiple-processor platform system comprising:
a platform comprising a plurality of processors including a designated boot-strap processor (BSP) and at least one application processor (AP);
a register the BSP having an address below 1 megabyte that includes an advanced programmable interrupt controller (APIC) base for the BSP;
a bus coupled to the at least one AP;
for each of the at least one AP:
a phase-locked loop that is internally coupled to a frequency goal memory-specific register; and
an APIC.

19. The multiple-processor platform system according to claim 18, the system further including:
a bridge coupled to the bus.

20. The multiple-processor platform system according to claim 18, the system further including:
a bridge coupled to the bus; and
an electrical connection to Vcc and to ground disposed between the bridge and the bus.

21. A computer-readable medium having computer-executable instructions for performing a method comprising:
designating a bootstrap processor (BSP) after a reset or a hard boot for a plurality of processors on a multiple-processor platform system; and
harmonizing common minimum and maximum bus-to-core ratios (MIN/MAX BCRs) for the plurality of processors before making random-access memory available in the system.

22. The computer-readable medium of claim 21, wherein harmonizing common MIN/MAX BCRs is carried out in read-only memory (ROM).

23. The computer-readable medium of claim 21, wherein designating a BSP comprises one of designating a BSP that is closest to a bridge that is coupled to the plurality of processors, designating a BSP according to its manufacture identification, and designating a BSP according to its duration on the platform in relation to the plurality of processors.
